(19) United States
(12) Patent Application Publication
(10) Pub. No.: US 2005/0277093 A1
(43) Pub. Date: Dec. 15, 2005

(54) Furniture template

(75) Inventors: Caron Kelly, Stuart, FL (US); John F. Justak, Stuart, FL (US)

Correspondence Address: HOLLAND & KNIGHT, LLP, ONE EAST BROWARD BLVD., SUITE 1300, FT LAUDERDALE, FL, 33301, US

(73) Assignee: Fantom Concepts LLC

(21) Appl. No.: 10/867,432

(22) Filed: Jun. 14, 2004

(51) Int. Cl. G09B 25/00

(52) U.S. Cl. 434/80

(57) ABSTRACT

This invention is directed to templates each consisting of a 2-dimensional sheet of light-weight, flexible material formed in the actual size of the footprint of an article of furniture. The sheets are easily transported from one location to another, and placed on the floor or wall of a room or other space to provide the viewer with an accurate depiction of the size of each furniture item and how multiple items can be arranged within a given space.

### FIELD OF THE INVENTION

This invention is directed to a furniture visualization apparatus, and, more particularly, to templates each consisting of a two-dimensional sheet of light-weight, flexible material formed in the actual size of the footprint of an article of furniture to assist with visualizing how such furniture would appear in a room or other space of given dimensions.

### BACKGROUND OF THE INVENTION

One of the difficulties confronted by interior designers, builders, architects and the like is to assist their clients in visualizing how objects will appear within a room or other space. Many people are unable to appreciate how articles of furniture, paintings and other items can be arranged together in a room, and whether their individual and collective size is appropriate for the space. Historically, design professionals have resorted to drawings, typically two-dimensional renditions on graph paper, in an effort to represent the relative size of furniture and other objects, as well as how such items fit together within a room. Drawings of this type provide little guidance for many people.

The shortcomings of current practices such as described above have been addressed in the prior art. U.S. Pat. No. 1,988,461 to Reeves, for example, discloses a system in which walls are formed to define the boundaries of a room of desired size and shape, and then life-sized, 3-dimensional articles of furniture are placed around the room. The Harris et al U.S. Pat. No. 2,221,766 teaches the use of blanks which fold into the shape of wall cabinets and base cabinets of the type found in kitchens or other rooms. Sheets or stickers which are painted or printed with the actual look of the front of a kitchen cabinet or other piece of furniture are affixed to the assembled blanks to simulate their actual appearance.

Systems of the type disclosed in the Reeves and Harris et al patents are expensive, inconvenient and impractical. Each design employs 3-dimensional furniture and/or walls which are difficult to store and impractical to transport from one location to another. Further, such furniture must be assembled on site, and then disassembled when a presentation to a client is completed. Using 3-dimensional shapes requires one to stock a large number of items in order to provide a client with an accurate depiction of a sofa, table, chair or other article of furniture of the desired size. This adds significantly to the expense of purchasing such items and storing them.

U.S. Pat. No. 2,293,441 to Meyer describes a system wherein a 2-dimensional rendition of different articles of furniture is drawn or otherwise provided on each of a number of separate sections of cardboard or the like, and flaps connected to the sections allow them to be held in an upright position for display. Each article of furniture is tiny, not life-sized, and they are positioned around a miniature depiction of a room. While this approach solves the assembly and storage problems identified above, it is difficult for many to visualize how furniture will look in an actual sized room by looking at a miniature scale model. As such, the Meyer system is considered no more effective that the drawings prepared by designers and others for their clients, as noted above.

### SUMMARY OF THE INVENTION

This invention is directed to templates for simulating the footprint of different articles of furniture, each of which consists of a 2-dimensional sheet of light-weight, flexible material such as olefin or neoprene formed in the actual size of the footprint of a piece of furniture. The sheets are easily transported from one location to another, and readily placed on the floor or wall of a room or other space to provide the viewer with an accurate depiction of the actual size of each furniture item and how multiple items can be arranged together within a given space.

In one presently preferred embodiment, each two-dimensional sheet has a top surface, a bottom surface and a peripheral edge. A stabilizing element is mounted to one of the top and bottom surfaces to assist in maintaining each sheet in a fixed position upon a support surface, e.g. a floor or wall. The stabilizing element may be one or more pockets filled with sand or other relatively heavy material, or hook-type fastening material, affixed at selected locations to the bottom surface of the sheets. The hook-type fastening material is preferably employed where the sheets are intended to be placed on a carpeted surface, whereas the sand-filled pockets can be used on wood floors, concrete or other smooth surfaces.

The top surface of the sheets are formed with spaced markings defining fold lines along which the sheets may be folded to reduce their length in at least one dimension. One or more spacers are mounted to the sheets which extend from their peripheral edge. Each spacer has a length dimension which is sized to permit even spacing of the sheets a desired distance from a wall or other object. Further, one or more bubble levels may be mounted to the sheets, particularly those intended for mounting to a wall for simulating a painting or the like, to allow for leveling of the sheets.

The templates of this invention provide life-sized footprints of different articles of furniture to aid in the visualization of how a room will look when furnished, while avoiding the pitfalls of the prior art. They are relatively inexpensive, easy to store and transport, require no assembly and can be rapidly placed around a room or other space, in different arrangements, as desired.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a plan view of one embodiment of the templates of this invention;

FIG. 2A is a cross sectional view taken generally along line 2A, B-2A, B of FIG. 1;

FIG. 2B is a cross-sectional view similar to FIG. 2A taken generally along line 2A,B-2A,B of FIG. 1, except depicting an alternative stabilizing element according to this invention;

FIG. 2C is an enlarged view of the circled portion of FIG. 2B.

FIG. 3 is a plan view of an alternative embodiment of a template herein;

FIG. 3A is a cross sectional view taken generally along line 3A-3A of FIG. 3;

FIG. 4 is a plan view of still another embodiment of the templates herein depicting fold lines spaced along the top surface thereof; and

FIG. 5 is a plan view of yet another embodiment of this invention in which horizontal and vertical bubble levels are mounted thereto.

### DETAILED DESCRIPTION OF THE INVENTION

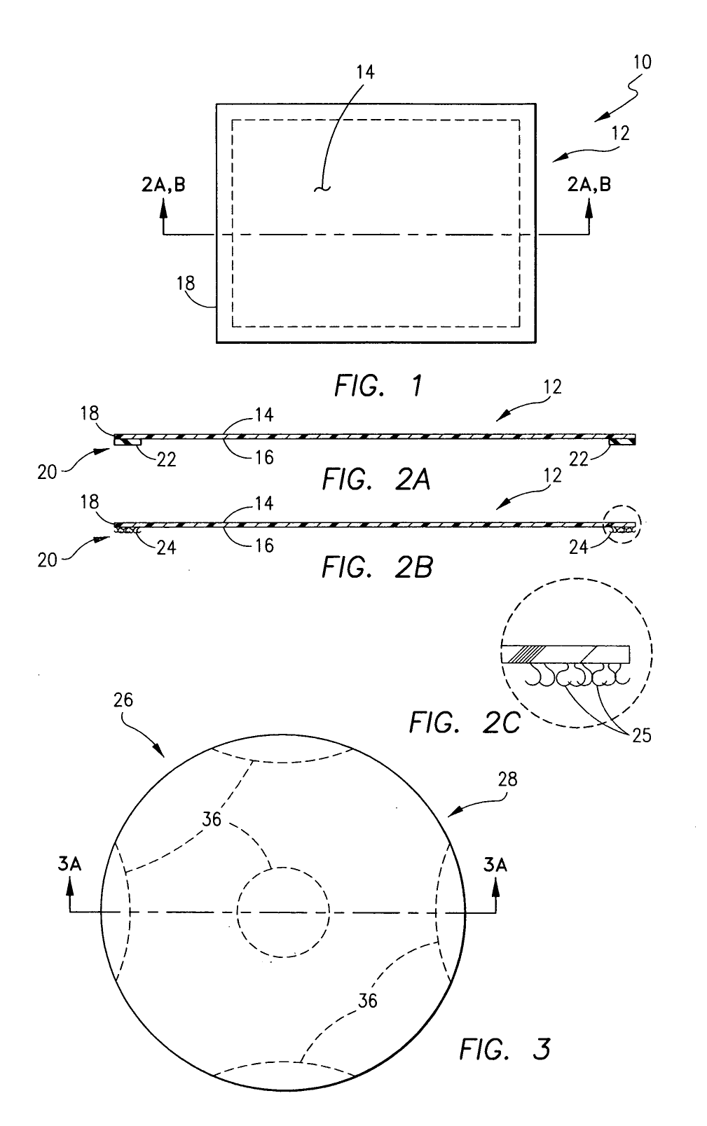

Referring initially to FIGS. 1-2C, a furniture template 10 is shown which comprises a two-dimensional sheet 12 of a light-weight, flexible material formed in the actual size of the footprint of an article of furniture such as an end table, cabinet or the like. The sheet 12 has a top surface 14, a bottom surface 16 and a peripheral edge 18. In the presently preferred embodiment, the sheet 12 is formed of Tyvek, a readily commercially available olefin sheet material, neoprene or similar flexible materials.

The template 10 is intended to be placed upon a support surface such as a floor to simulate the footprint of an actual-sized article of furniture and thus aid in the visualization of such item in a room or other space. In order to assist in retaining the template 10 in position on the support surface, the sheet 12 is provided with one or more stabilizing elements 20 mounted preferably to the bottom surface 16 of the sheet 12. In the embodiment of FIG. 2A, the stabilizing element 20 is shown in the form of a closed pocket 22 connected by adhesive, stitching or the like to the bottom surface 16 about the peripheral edge 18 of the sheet 12. The pocket 22 may be filled with sand, lead weights or essentially any other material which adds weight to sheet 12 and helps hold it on a support surface.

Alternatively, as shown in FIGS. 2B and 2C, the stabilizing element 20 may comprise one or more strips 24 of hook-type fastening elements 25 mounted to the bottom surface 16 in the same positions as the pocket 22. It is contemplated that the strips 24 will be employed when the templates 10 are placed upon carpeting, fabric or the like so that the hook-type fastening elements may engage and interlock to some extent with the fibers of the carpet or fabric and help maintain the template 10 in place. The template 10 with the pocket 22, on the other hand, is more useful on smooth support surfaces such as concrete or wood floors.

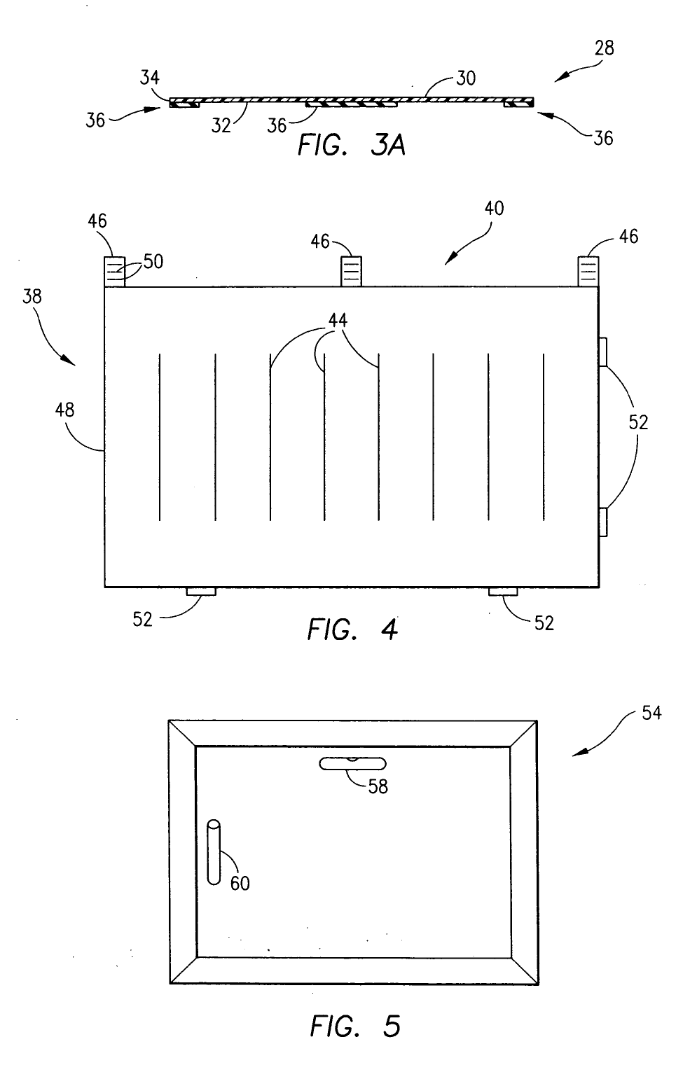

While the stabilizing element 20 of FIGS. 1-2C is shown affixed to the bottom surface 16 of sheet 12 around its peripheral edge 18, it should be understood that stabilizing elements 20 may be positioned essentially anywhere along the bottom surface 16. With reference to FIGS. 3 and 3A, another furniture template 26 which is round in shape is shown. Template 26 is formed of a sheet 28 of the same material as sheet 12, with a top surface 30, bottom surface 32 and peripheral edge 34. A number of stabilizing elements 36, formed in the same way as pockets 22 or strips 24 of FIGS. 1-2A, are mounted at discreet locations to the bottom surface 32 by adhesive, stitching or other permanent means. The stabilizing elements 36 perform the same function in the template 26 of this embodiment as the stabilizing elements 20 of FIGS. 1-2B.

Other features of the furniture templates of this invention are depicted in FIGS. 4 and 5. In FIG. 4, a template 38 is shown comprising a sheet 40 of the same material as in FIGS. 1-3A formed in the footprint of a sofa or bed. The top surface 42 of the sheet 40 has a number of spaced markings 44 defining fold lines along which the sheet 40 can be folded to vary the length of template 38 and thus simulate sofas of different length, for example. Spacers 46 protrude from the peripheral edge 48 of the sheet 40, and although three are shown in FIG. 4 it should be understood that more or less may be employed. The purpose of spacers 46 is to assist in evenly positioning the template 38 a desired distance from a wall or object. Markings 50 are provided on each spacer 46 to define fold lines allowing the user to change the length of the spacers 46, and, hence, the position of the template 38 relative to a wall or the like. The template 38 may included stabilizing elements (not shown) of the same type as employed in the previously described embodiments.

The template 38 of FIG. 4 further includes one or more connectors 52 protruding from its peripheral edge 48 at the locations shown in the drawing. The connectors 52 may comprise a magnet, magnetic material, snaps, hook and loop fastener material and the like. Each one of a number of templates 38 (or templates 10 and 26) include connectors 52 to enable adjacent templates 38 to be joined together for display. This allows the designer to depict furniture of different length (for example sofas), or different width (for example beds), using multiple templates 38 connected together side-by-side or end-to-end.

In FIG. 5, a template 54 is illustrated which is formed of the same sheet material as in the previous embodiments. The template 54 has a beveled top surface 56 and is provided with bubble levels 58 and 60, allowing it to be leveled on a wall in either the vertical or horizontal orientation to simulate the appearance of artwork or the like.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

For example, the templates 10, 38 and 54 are depicted as having a generally rectangular shape whereas the template 26 is round. It is contemplated that the templates herein could be essentially any shape required to simulate the appearance of the footprint of a particular article of furniture.

Therefore, it is intended that the invention not be limited to the particular embodiment disclosed as the best mode contemplated for carrying out this invention, but that the invention will include all embodiments falling within the scope of the appended claims.

1. A template for simulating the footprint of an article of furniture, comprising:
a two-dimensional sheet of light weight, flexible material formed in the actual size of the footprint of an article of furniture, said two-dimensional sheet having a top surface and a bottom surface; and
a stabilizing element mounted to one of said top and bottom surfaces to assist in maintaining said two-dimensional sheet in a fixed position upon a support surface.

2. The template of claim 1 in which said two-dimensional sheet is formed of olefin.

3. The template of claim 1 in which said two-dimensional sheet is formed of neoprene.

4. The template of claim 1 in which said two-dimensional sheet has a periphery, said stabilizing element comprising a pocket mounted to said bottom surface about at least a portion of said periphery, said pocket being filled with material which adds weight to said two-dimensional sheet.

5. The template of claim 4 in which said stabilizing element is a section of hook-type fastening elements mounted to said bottom surface along at least a portion of said periphery.

6. The template of claim 1 in which said stabilizing element is a number of pockets mounted at discreet locations to said bottom surface of said two-dimensional sheet, each of said pockets being filled with material which adds weight to said two-dimensional sheet.

7. The template of claim 1 in which said stabilizing element is a number of sections of hook-type fastening material mounted at discreet locations to said bottom surface of said two-dimensional sheet.

8. The template of claim 1 in which said two-dimensional sheet has a peripheral edge, said two-dimensional sheet further including at least one spacer protruding from said peripheral edge, said at least one spacer having a length dimension which allows said two-dimensional sheet to be positioned a desired distance from a wall or an object.

9. The template of claim 8 in which said at least one spacer is formed within spaced markings defining fold lines along which said at least one spacer may be folded to vary said length dimension thereof.

10. The template of claim 1 in which said top surface is formed with a number of spaced markings, said markings defining fold lines along which said two-dimensional sheet may be folded to vary at least one of its dimensions.

11. The template of claim 10 in which said template has a length dimension and a width dimension, said markings being spaced on said top surface along said length dimension.

12. The template of claim 1 further including at least one bubble level mounted to said two-dimensional sheet, said at least one bubble level being effective to permit leveling of said two-dimensional sheet when mounted on a surface.

13. A template for simulating the footprint of an article of furniture, comprising:
a two-dimensional sheet of light-weight, flexible material formed in the actual size of the footprint of an article of furniture, said two-dimensional sheet having a top surface, a bottom surface and a peripheral edge;
at least one spacer protruding from said peripheral edge, said at least one spacer having a length dimension which allows said two-dimensional sheet to be positioned a desired distance from a wall or an object.

14. The template of claim 13 in which said at least one spacer is formed with spaced markings along the length thereof, said markings defining fold lines along which said spacer may be folded to vary the length thereof sand thus vary said position of said two-dimensional sheet relative to a wall or an object.

15. The template of claim 13 further including a stabilizing element mounted to one of said top and bottom surfaces to assist in maintaining said two-dimensional sheet in a fixed position upon a support surface.

16. The template of claim 13 in which said two-dimensional sheet is formed of olefin.

17. The template of claim 13 in which said two-dimensional sheet is formed of neoprene.

18. The template of claim 13 in which said top surface is formed with a number of spaced markings, said markings defining fold lines along which said two-dimensional sheet may be folded to vary at least one of its dimensions.

19. The template of claim 18 in which said template has a length dimension and a width dimension, said markings being spaced on said top surface along said length dimension.

20. A template for simulating the footprint of an article of furniture, comprising:
a two-dimensional sheet of neoprene formed in the actual size of the footprint of an article of furniture;
said two-dimensional sheet of neoprene being movable between a folded and unfolded position, and being capable of remaining in a substantially fixed position on a support surface in said unfolded position.
